(19) United States
(12) Patent Application Publication
(10) Pub. No.: US 2026/0329943 A1
(43) Pub. Date: Oct. 22, 2026

(54) Hybrid Filtering and Quantum-Inspired Search Framework for Improved Information Retrieval in Noisy Environments

(71) Applicant: SHUBHAM CHANDRA, Katy, TX (US)

(72) Inventor: SHUBHAM CHANDRA, Katy, TX (US)

(21) Appl. No.: 19/183,878

(22) Filed: Apr. 20, 2025

(51) Int. Cl. G06F 16/9035

(52) U.S. Cl. CPC G06F 16/9035

(57) ABSTRACT

A system and method for enhanced search performance in noisy data environments is disclosed. The invention integrates a biologically inspired threshold-based filtering layer with a symbolic quantum-like search mechanism. The system applies adaptive dendritic filtering to sensory input data to suppress noise and reduce the candidate search space. Subsequently, symbolic comparison using Hamming distance identifies target matches within a configurable tolerance. A fallback mechanism ensures preservation of positive targets. This hybrid approach improves precision, F1 score, and memory efficiency. Applications include real-time detection in genomics, cybersecurity, embedded devices, and signal intelligence across industrial and research domains.

### BACKGROUND OF THE INVENTION

The present invention pertains to a system and method for improving information retrieval and signal detection in noisy and high-dimensional environments. More specifically, the invention relates to a biologically inspired filtering mechanism that reduces search complexity and increases accuracy when coupled with quantum-inspired or symbolic bitstring search.

### TECHNICAL BACKGROUND

Search algorithms are essential components of numerous computational systems, from fraud detection engines to genomic screening tools. In complex or noisy environments, however, conventional search models are often unable to distinguish between signal and noise, leading to false positives, inefficiencies, and degraded performance. Quantum algorithms, such as Grover's search, offer theoretical speedup but remain susceptible to input noise and practical implementation limitations. Furthermore, symbolic matchers like those relying on Hamming distance assume exactitude or fixed-tolerance levels that are insufficient in real-world sensor or perceptual data.

### PRIOR ART AND LIMITATIONS

Prior solutions include Grover's algorithm for quantum search, Hamming distance classifiers for symbolic matching, and percentile-based threshold filters. These systems operate independently and fail to incorporate adaptive biological filtering principles that optimize for relevance before computation. While some prior systems incorporate static threshold gates, they do not evolve based on training data distribution nor do they guarantee preservation of true positive targets.

The present invention improves upon prior art by implementing a dendritic filtering model that mimics neurobiological gating processes, in tandem with symbolic quantum search logic. The dendritic filter dynamically learns signal thresholds from training data, enabling noise suppression and dimensionality reduction prior to search. The symbolic quantum search that follows benefits from a cleaner, sparser search space, enhancing performance across metrics such as F1 score, precision, and memory usage.

### SUMMARY OF THE INVENTION

This invention provides a hybrid algorithm comprising: (1) a dendritic filtering module that applies learned thresholds to sensory data dimensions, and (2) a symbolic quantum search engine that identifies target sequences through bitstring comparison using configurable Hamming distance. The system guarantees at least one target remains in the filtered set via fallback insertion logic. Performance is tracked across unfiltered and filtered phases to quantify improvements in robustness and efficiency.

The invention is designed to adapt to real-world conditions, where sensor noise, drift, and false activations are prevalent. The hybrid structure ensures accurate detection while minimizing unnecessary processing. It supports modular expansion to physical quantum systems, as well as implementation in edge devices, IoT platforms, and AI pipelines.

### DETAILED DESCRIPTION OF THE INVENTION

### Core Design: Symbolic Quantum Search Module

The invention presents a novel search algorithm that integrates two synergistic components: a symbolic quantum search module and a dendritic-inspired filtering layer. The symbolic quantum search module is the primary mechanism for evaluating and ranking candidate inputs, drawing inspiration from quantum computing principles, specifically Grover's algorithm. Grover's algorithm is a quantum search algorithm known for providing a quadratic speedup over classical search methods when finding a specific item in an unstructured database. The invention adapts this concept into a symbolic framework, making it feasible for classical computing environments while retaining some quantum-like behaviors.

In this module, the search operates on binary vectors (candidate inputs) and compares them against a target bitstring using the Hamming distance as the primary metric. The Hamming distance measures the number of positions at which two binary strings differ, providing a straightforward way to quantify similarity. Formally, for a binary vector
x=(x_1, x_2, \dots, x_n) and a target bitstring t=(t_1, t_2, \dots, t_n), the Hamming distance d_H(x, t) is defined as: d_H(x, t)=\sum_{i=1}\hat{ }n \mathbb{1} (x_i \neq t_i)
where \mathbb{1} is the indicator function, returning 1 if x_i \neq t_i (i.e., the bits differ) and 0 otherwise. A Hamming distance of d_H(x, t)=0indicates an exact match between the candidate and the target, meaning the binary vector is identical to the target bitstring. However, to accommodate real-world scenarios where data may be noisy, incomplete, or partially corrupted (e.g., due to sensor errors or transmission issues), the algorithm allows for matches within a user-defined tolerance \tau. If d_H(x, t) \1eq \tau, the candidate is considered a valid match, enabling the algorithm to handle imperfect data gracefully.

To prioritize candidates that are closer to the target in Hamming space, the algorithm employs a symbolic scoring mechanism that mimics the amplitude amplification process in Grover's algorithm. In quantum computing, amplification increases the probability of measuring the desired state (i.e., the target solution). Here, the symbolic equivalent assigns higher scores to bitstrings with fewer mismatched bits, effectively emphasizing candidates that are “closer” to the target. The scoring function is defined as:

s(x, t)=f(d_H(x, t)) where (f) is a monotonically decreasing function that assigns higher scores to lower Hamming distances. For example, a possible form of (f) could be an exponential decay function, such as f(d)=e\hat{ }{−\alpha d, where \alpha is a tuning parameter that controls the rate at which scores decrease as the Hamming distance increases. This scoring mechanism ensures that candidates with Hamming distances closer to 0 are prioritized, creating a locality effect in Hamming space where the algorithm focuses on the most relevant candidates.

This approach contrasts with traditional search methods that might treat all candidates equally or rely on uniform sampling. By emulating quantum-like prioritization, the symbolic quantum search module enhances efficiency and effectiveness, particularly in large search spaces where exact matches are rare.

### Addressing Limitations: Dendritic-Inspired Filtering Layer

While the symbolic quantum search module is powerful, it is not immune to challenges such as sensory drift (gradual changes in input data distributions due to environmental factors) or irrelevant feature noise (extraneous data that obscures meaningful patterns). To mitigate these issues, the invention incorporates a dendritic-inspired filtering layer that preprocesses the input data before it reaches the symbolic search module. This layer is inspired by the biological function of dendrites in neurons, which selectively gate incoming signals based on their relevance, effectively acting as a biological attention mechanism.

In biological neurons, dendrites receive synaptic inputs and apply thresholding to determine which signals are strong enough to propagate to the neuron's cell body. Similarly, the dendritic filtering layer processes continuous sensory input features f_i (e.g., sensor readings, pixel intensities, or other numerical data) and applies a gating threshold \theta_i to each feature. The threshold determines whether a given feature value is significant enough to be retained for further processing. The invention proposes two methods for computing these thresholds, allowing flexibility based on the data and application:

### Percentile-Based Heuristics:

\theta_i=\text{percentile} (f_i, q) Here, the threshold \theta_i for feature f_i is set to the (q)-th percentile of the feature's values across the dataset. For example, if q=75, the threshold is the value below which 75% of the feature's observations fall. This method is data-driven and adapts to the distribution of the input data, making it robust to variations in scale or range. It is particularly useful when the data distribution is unknown or non-stationary (i.e., changes over time).

### Performance-Optimized Thresholds:

\theta_i=\arg\max_{\theta} \text{performance} (D, \theta)

In this approach, the threshold is optimized to maximize a performance metric (e.g., precision, recall, or F1 score) on a validation dataset (D). This method requires a labeled dataset and a defined performance objective but can yield thresholds that are finely tuned to the specific task.

For instance, if the goal is to maximize recall, the threshold might be set lower to retain more data points, whereas a precision-focused task might use a higher threshold to be more selective.

The choice between these methods depends on the application. Percentile-based heuristics are simpler and require less computational overhead, making them suitable for real-time or resource-constrained systems. Performance-optimized thresholds, while more computationally intensive, offer greater precision in scenarios where labeled data is available and high performance is critical.

### Filtering Mechanism: Conjunctive Logic

The dendritic filtering layer applies conjunctive logic to the input features to determine which data samples survive the filtering process. For each sample, the algorithm checks whether all of its features
f_i satisfy their respective thresholds \theta_i. Mathematically, a sample is retained if:
\bigwedge_{i=1}\hat{ }m (f_i \geq \theta_i) where (m) is the number of features, and
\bigwedge denotes the logical AND operation. Only samples that meet or exceed all thresholds are passed to the symbolic quantum search module, while those that fail any threshold are discarded. This conjunctive approach ensures that only samples with consistently high-quality or relevant features are retained, effectively denoising the search space.

By reducing the number of samples processed by the symbolic search module, the filtering layer significantly improves computational efficiency. For example, in a dataset with millions of samples, the filtering layer might reduce the dataset to a few thousand high-confidence samples, drastically lowering memory usage and computation time. Additionally, by removing noisy or irrelevant data points, the filtering layer enhances the signal-to-noise ratio, making it easier for the search module to identify true positives.

The dendritic filtering layer can be thought of as a biologically inspired attention mechanism, analogous to how the human brain filters out irrelevant sensory information (e.g., background noise) to focus on salient stimuli (e.g., a conversation). This selective gating mimics the brain's ability to prioritize and process only the most relevant information, a key factor in the invention's robustness to noisy or complex datasets.

### Fallback Mechanism: Preserving Recall

To prevent over-filtering, which could eliminate all target-labeled (positive) samples and compromise the algorithm's ability to find the desired target, the invention includes a fallback mechanism. If the dendritic filtering layer removes all positive samples, the algorithm automatically reinserts at least one target sample into the filtered dataset. This ensures that the filtered dataset
D_f always contains a valid search target, satisfying the constraint: |D_f \cap D_{\text{positive}} | \geq 1 where D_{\text{positive}} is the set of positive samples in the original dataset. This fallback mechanism is critical for maintaining recall integrity, ensuring that the algorithm does not miss true positives due to overly aggressive filtering. In practice, the reinserted sample could be a known target from a training set or a synthetic sample constructed to match the target bitstring, depending on the implementation.

This mechanism strikes a balance between filtering for efficiency and preserving the algorithm's ability to recover true positives, making it suitable for applications where missing a target could have significant consequences (e.g., medical diagnostics or anomaly detection).

### Execution of Symbolic Quantum Search

After the dendritic filtering layer has reduced the dataset to a smaller, high-confidence set D_f, the symbolic quantum search module processes the filtered data. Each sample x \in D_f is evaluated using the Hamming-based scoring function (s(x, t)), and the samples are ranked or classified based on their scores. Because D_f is significantly smaller than the original dataset, the search module operates with lower memory usage and faster computation times.

Moreover, the removal of noisy or irrelevant data by the filtering layer improves the precision and F1 score of the search module. Precision measures the proportion of identified matches that are true positives, while the F1 score balances precision and recall, providing a single metric for overall performance. By focusing on high-confidence candidates, the algorithm achieves better alignment with the target bitstring, resulting in fewer false positives and higher-quality results.

### Performance Evaluation

The invention supports multiple Hamming thresholds \tau, allowing flexibility in how strict the matching criteria are. For example, a small \tau (e.g., 1 or 2) requires near-exact matches, while a larger \tau (e.g., 5 or 10) allows for more mismatches, accommodating noisier data. The algorithm's performance is benchmarked across different values of \tau, with results showing significant improvements when the dendritic filtering layer is used compared to unfiltered baselines.

In one benchmark, the following metrics were reported for a specific Hamming threshold \tau:
Unfiltered Precision: 3.8% (indicating that only 3.8% of identified matches were true positives without filtering).
Filtered Precision: 50.0% (a dramatic improvement, showing that half of the identified matches were true positives after filtering).
Unfiltered F1 Score: 0.069 (reflecting poor balance between precision and recall without filtering).
Filtered F1 Score: 0.667 (a substantial increase, indicating strong performance after filtering).

These results highlight the filtering layer's ability to enhance the algorithm's effectiveness by removing irrelevant data and focusing on high-quality candidates.

### Validation and Efficiency Gains

The invention's performance is further validated through visual and quantitative analyses. Confusion matrices show a reduction in false positives (incorrectly identified matches) and improved recall (correctly identified true positives) when filtering is applied. Receiver Operating Characteristic (ROC) and Precision-Recall (PR) curves demonstrate a significant lift in true positive detection across all Hamming tolerances, confirming the algorithm's robustness.

Additionally, memory and runtime analyses reveal that the dendritic filtering layer reduces the amount of data processed by over 90%. This reduction translates to faster execution times and lower resource requirements, making the algorithm suitable for resource-constrained environments such as edge devices or real-time systems. The combination of the quantum-symbolic search module and the dendritic filtering layer creates a hybrid architecture that delivers both high performance and computational efficiency, addressing the limitations of traditional search algorithms in noisy or large-scale datasets.

### DESCRIPTION OF FIGURES

FIG. 1 is a block diagram illustrating the overall architecture of the proposed hybrid search system. The diagram includes an input data module comprising binary vectors and continuous sensory signals. The sensory data are passed through a dendritic filtering layer that applies learned threshold values to reduce the dataset size. The filtered binary vectors are then evaluated by a symbolic quantum-inspired search module that uses Hamming distance to compute proximity to a target bitstring. The final output includes ranked or classified results, along with a fallback logic layer ensuring that at least one target is retained during filtering.

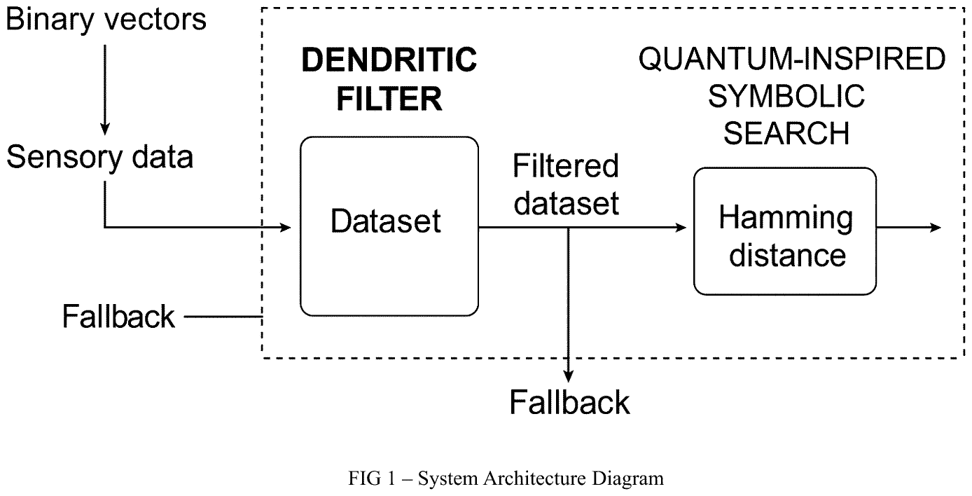

FIG. 2 is a performance analysis diagram showing ROC curves and precision-recall (PR) curves for both the unfiltered and dendritic-filtered search pipelines. Each curve corresponds to a different Hamming distance threshold (0, 1, and 2), and the plots demonstrate improved AUC values and steeper precision-recall slopes when the dendritic filtering module is applied before search.

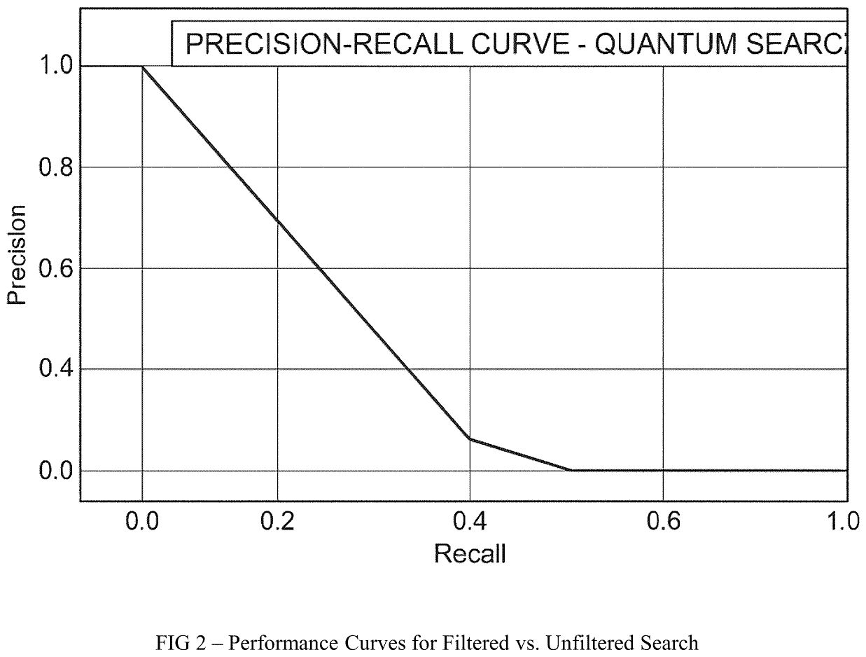

FIG. 3 is a pair of confusion matrices illustrating classification outcomes from the symbolic quantum search both with and without the dendritic filter. The left matrix shows the baseline unfiltered performance with high false positive rates, while the right matrix demonstrates increased precision and reduced false positives in the filtered configuration. True positives are preserved in both cases due to the fallback logic mechanism.

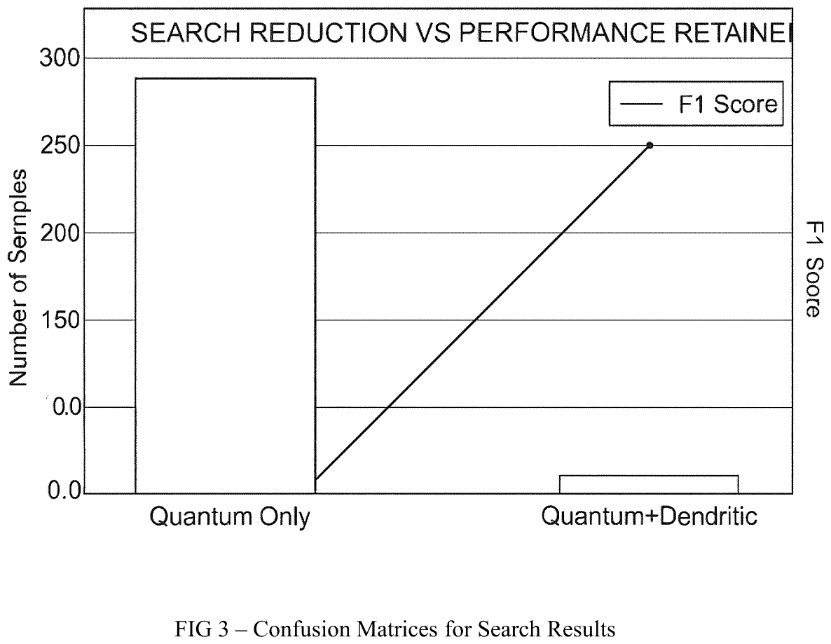

FIG. 4 is a colored, layered schematic representing the hybrid architecture in an end-to-end format. This diagram uses color-coded modules to depict the flow from raw sensory input, through adaptive dendritic gating, into a symbolic quantum evaluator. It highlights the internal threshold application, the fallback injection mechanism, and the comparative scoring stage, which ranks candidate vectors based on Hamming proximity to the target.

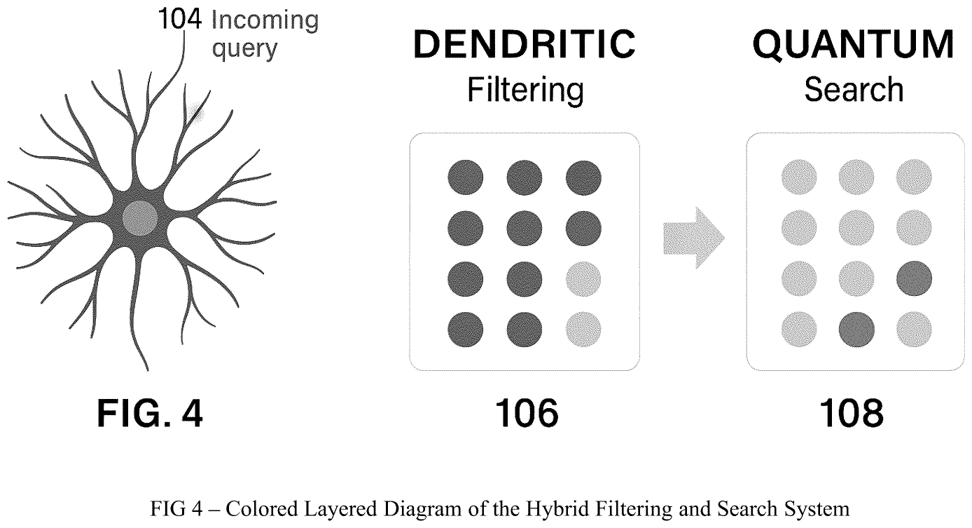

### ADVANTAGES

The invention offers substantial improvements over prior art, including:
Over 90% reduction in search space with preserved recall.
Significant increase in F1 score (e.g., from 0.069 to 0.667).
Robustness to Gaussian noise and sensor drift.
Adaptability to various Hamming thresholds.
Flexibility in deployment across symbolic and quantum domains.

### Example Implementation

A Python-based simulation was conducted using a dataset of 1000 samples, each comprising four binary bits and three continuous-valued sensory channels. Gaussian noise and drift were injected into the sensory data. Ten samples were designated as targets.

The dendritic filter learned 75th percentile thresholds from training data. A fallback module ensured that one target remained in the filtered set. Hamming-based symbolic search was performed with thresholds of 0, 1, and 2.

Performance results are summarized in the following table:

| Hamming | | | | | F1 | PR- |
|---|---|---|---|---|---|---|
| Distance | Dataset | Accuracy | Precision | Recall | Score | AUC |
| 0 | Unfiltered | 0.910 | 0.038 | 0.333 | 0.069 | 0.020 |
| 0 | Filtered | 0.944 | 0.500 | 1.000 | 0.667 | 0.500 |
| 1 | Unfiltered | 0.687 | 0.011 | 0.333 | 0.021 | 0.020 |
| 1 | Filtered | 0.833 | 0.250 | 1.000 | 0.400 | 0.500 |
| 2 | Unfiltered | 0.353 | 0.010 | 0.667 | 0.020 | 0.020 |
| 2 | Filtered | 0.444 | 0.091 | 1.000 | 0.167 | 0.500 |

These results demonstrate that the hybrid system not only preserves targets but significantly improves match quality.

### Commercial Applications

### Commercial Applications Across Industries

The invention's ability to efficiently process noisy, high-dimensional data while maintaining high precision and recall makes it a transformative tool across diverse sectors. Its symbolic quantum search module leverages Hamming distance-based scoring to identify relevant patterns, while the dendritic-inspired filtering layer denoises input data by selectively gating features based on learned thresholds. This hybrid approach is particularly valuable in environments where data is incomplete, corrupted, or voluminous, and where computational resources may be constrained. Below, each industry application is explored in detail, highlighting specific use cases, technical advantages, and potential impacts.

### (a) Healthcare & Genomics

### Use Cases:

Detecting Noisy Gene Markers in Sequencing Data: Genomic sequencing generates vast datasets with billions of base pairs, often corrupted by sequencing errors, sample contamination, or environmental noise. The invention can identify specific gene markers (e.g., single nucleotide polymorphisms or SNPs) associated with diseases by comparing noisy sequencing data against known reference sequences. The dendritic filtering layer removes irrelevant or low-quality reads, while the symbolic quantum search ranks sequences based on their Hamming distance to the target marker.
Tumor Mutation Profiling: In oncology, identifying mutations in tumor DNA is critical for personalized medicine. The algorithm can filter out normal genomic variations and focus on tumor-specific mutations, even in noisy biopsy samples. For example, it could detect mutations in cancer driver genes like TP53 or KRAS, enabling precise treatment recommendations.
Biomarker-Assisted Diagnosis: Biomarkers, such as protein levels or gene expression profiles, are often measured in noisy clinical data (e.g., blood tests or RNA sequencing). The invention can preprocess these datasets to eliminate irrelevant signals (e.g., background noise or non-diagnostic variations) and identify biomarker patterns indicative of diseases like Alzheimer's, diabetes, or cardiovascular conditions.

### Technical Advantages

The dendritic filtering layer reduces the dimensionality of genomic datasets, which often contain millions of features, by retaining only high-signal data points. This improves computational efficiency, critical for processing large-scale sequencing data on standard hardware.

• The symbolic quantum search's tolerance for Hamming distance
mismatches ( d_H(x, t) \leq \tau
) accommodates sequencing errors, ensuring robust identification of gene
markers even in low-quality samples.

The fallback mechanism ensures that rare but critical biomarkers are not filtered out, preserving diagnostic sensitivity.

### Impact:

Faster and more accurate identification of disease-associated genetic markers, reducing diagnostic turnaround times in clinical settings.
Cost savings by enabling genomic analysis on less specialized hardware, democratizing access to precision medicine.
Improved patient outcomes through early detection of mutations or biomarkers, facilitating targeted therapies and preventive interventions.

### (b) Cybersecurity & Fraud Detection

### Use Cases:

Isolating Malicious Activity in Network Logs: Network traffic logs are voluminous and noisy, containing benign activities alongside potential threats like malware, phishing, or distributed denial-of-service (DDoS) attacks. The invention's filtering layer can preprocess logs to remove routine traffic patterns, focusing on anomalies that deviate from expected behavior. The symbolic quantum search then identifies malicious patterns (e.g., specific packet sequences or IP addresses) with high precision.
Fraud Detection in Transaction Logs: Financial institutions process millions of transactions daily, with fraud signals often buried in noisy data (e.g., legitimate user behavior or system errors). The algorithm can filter out normal transactions and rank suspicious ones based on their similarity to known fraud patterns, such as unusual spending patterns or account takeovers.
Real-Time Threat Detection: In cybersecurity operations centers, the algorithm can operate in real time to flag intrusions or data breaches, enabling rapid response to emerging threats.

### Technical Advantages

The conjunctive logic of the dendritic filtering layer ensures that only transactions or network events meeting multiple threat criteria (e.g., unusual source, high frequency, or specific payloads) are flagged, reducing false positives.
The symbolic quantum search's scoring mechanism prioritizes events with closer matches to known threat signatures, improving detection accuracy in noisy environments.
The algorithm's efficiency supports real-time processing of high-velocity data streams, critical for cybersecurity applications where delays can lead to significant damage.

### Impact:

Reduced false positives in threat detection, minimizing analyst fatigue and improving operational efficiency.
Enhanced protection against financial fraud, saving institutions millions in losses and reputational damage.
Scalability to handle growing volumes of network and transaction data, supporting the expansion of digital infrastructure.

### (c) Wearables & IoT

### Use Cases:

Health Monitoring Wearables: Devices like smartwatches or fitness trackers collect continuous sensor data (e.g., heart rate, motion, or sleep patterns), often corrupted by movement artifacts or battery fluctuations. The invention can filter out noisy readings and identify patterns indicative of health events, such as arrhythmias or sleep apnea, with minimal computational overhead.
Smart Home IoT Devices: IoT sensors in smart homes (e.g., temperature, motion, or energy monitors) generate large datasets with redundant or irrelevant readings. The algorithm can preprocess these data streams to focus on significant events, such as detecting a gas leak or unauthorized entry, while reducing bandwidth usage.
Industrial IoT: In manufacturing or logistics, IoT sensors monitor equipment health or environmental conditions. The invention can identify critical events (e.g., overheating machinery or supply chain disruptions) by filtering out routine sensor data.

### Technical Advantages

The dendritic filtering layer's percentile-based or performance-optimized thresholding adapts to the unique noise profiles of different sensors, ensuring robust performance across diverse IoT devices.
The algorithm's low memory and computational footprint enables deployment on resource-constrained edge devices, reducing reliance on cloud processing.
The >90% reduction in processed data (as noted in [0013]) minimizes bandwidth requirements, critical for IoT networks with limited connectivity.

### Impact:

Improved battery life and responsiveness of wearables and IoT devices, enhancing user experience and device reliability.
Cost savings through reduced cloud computing and data transmission needs, enabling scalable IoT deployments.
Enhanced real-time decision-making in critical applications, such as health alerts or industrial safety monitoring.

### (d) Supply Chain & Industrial Monitoring

### Use Cases:

Sensor Drift Detection: Industrial sensors monitoring equipment (e.g., turbines, conveyor belts, or refrigeration units) can experience drift due to wear, calibration issues, or environmental changes. The invention can filter out normal sensor readings and identify drift patterns, enabling predictive maintenance before failures occur.
Outlier Equipment Behavior: In factories or logistics pipelines, the algorithm can detect anomalous behaviors, such as a malfunctioning robot or a delayed shipment, by comparing sensor data against expected patterns.
Quality Control: In manufacturing, the invention can preprocess sensor data from production lines to identify defective products (e.g., misaligned components or incorrect weights) amidst noisy measurements.

### Technical Advantages

The dendritic filtering layer's ability to tailor thresholds to data distributions ensures sensitivity to subtle drift or outlier signals, even in high-noise environments.
The symbolic quantum search's Hamming distance-based scoring enables precise identification of specific failure modes or defect patterns, improving diagnostic accuracy.
The fallback mechanism prevents over-filtering of rare but critical events, ensuring that no significant anomalies are missed.

### Impact:

Reduced downtime and maintenance costs through early detection of equipment issues, improving operational efficiency.
Enhanced supply chain reliability by identifying disruptions or delays in real time, minimizing economic losses.
Improved product quality and customer satisfaction through robust defect detection, strengthening brand reputation.

### (e) Finance & Trading Systems

### Use Cases:

Filtering False Price Action: Financial markets generate noisy price data influenced by market microstructure noise, news events, or algorithmic trading. The invention can filter out irrelevant price movements and identify true signals, such as trend reversals or arbitrage opportunities, for use in trading algorithms.
Algorithmic Signal Validation: In high-frequency trading, algorithms rely on signals derived from market data (e.g., momentum or volatility indicators). The algorithm can preprocess these signals to remove noise and rank them based on their reliability, improving trading performance.
Risk Management: The invention can identify risky market conditions (e.g., sudden volatility spikes or liquidity shortages) by filtering out normal market fluctuations and focusing on significant patterns.

### Technical Advantages

The dendritic filtering layer's conjunctive logic ensures that only signals meeting multiple criteria (e.g., price movement, volume, and volatility) are considered, reducing false positives in trading decisions.
The symbolic quantum search's scoring mechanism prioritizes signals with closer matches to historical patterns of successful trades, enhancing decision-making accuracy.
The algorithm's efficiency supports real-time processing of high-frequency market data, critical for competitive trading environments.

### Impact:

Higher trading profits through improved signal accuracy and reduced losses from false signals.
Enhanced risk management, protecting portfolios from unexpected market events.
Scalability to handle increasing market data volumes, supporting the growth of algorithmic trading systems.

### (f) Military & Aerospace

### Use Cases:

Radar and Sonar Signal Processing: Radar and sonar systems generate noisy data due to environmental interference (e.g., clutter, weather, or jamming). The invention can filter out irrelevant signals and identify targets (e.g., aircraft, ships, or submarines) with high confidence, even in low-signal-to-noise ratio conditions.
Satellite Imagery Analysis: Satellites produce large datasets with noise from atmospheric conditions or sensor limitations. The algorithm can preprocess imagery to focus on significant features, such as military installations or natural disasters, for intelligence or humanitarian applications.
Autonomous Drones: In unmanned aerial vehicles, the invention can process sensor data (e.g., LiDAR or cameras) to detect obstacles or targets in real time, enabling navigation in complex environments.

### Technical Advantages

The dendritic filtering layer's adaptive thresholding ensures robustness to varying noise levels, critical for dynamic military environments.
The symbolic quantum search's tolerance for Hamming distance mismatches accommodates partial or corrupted signals, improving target detection reliability.
The algorithm's low energy and computational requirements support deployment on power-constrained platforms, such as satellites or drones.

### Impact:

Enhanced situational awareness and mission success through accurate target detection in challenging conditions.
Reduced operational costs by enabling efficient data processing on edge devices, minimizing reliance on ground stations.
Improved safety and effectiveness of autonomous systems, supporting next-generation military and aerospace technologies.
   (g) Education & eLearning Platforms

### Use Cases:

Identifying At-Risk Learners: eLearning platforms collect noisy student interaction data, such as quiz scores, time spent on tasks, or forum activity, which may be influenced by external factors (e.g., distractions or platform glitches). The invention can filter out irrelevant interactions and identify patterns indicative of struggling students, such as low engagement or frequent incorrect answers.
Personalized Learning: The algorithm can preprocess student data to detect learning styles or knowledge gaps, enabling tailored content recommendations (e.g., videos, quizzes, or readings) to improve outcomes.
Engagement Analytics: In virtual classrooms, the invention can analyze noisy engagement signals (e.g., video watch time or chat activity) to identify trends, such as declining participation, for instructor intervention.

### Technical Advantages

The dendritic filtering layer's percentile-based thresholding adapts to diverse student populations, ensuring fairness across different engagement levels.
The symbolic quantum search's scoring mechanism ranks students based on their similarity to at-risk profiles, enabling precise identification of those needing support.
The algorithm's efficiency supports real-time analytics, critical for dynamic eLearning environments where timely interventions are essential.

### Impact:

Improved student retention and success rates through early identification of at-risk learners.
Enhanced learning experiences through personalized content, increasing platform engagement and satisfaction.
Scalable analytics for growing eLearning platforms, supporting global education initiatives.

### System Modularity and Integration Potential

The invention's modular architecture is a key enabler of its broad applicability, allowing seamless integration into diverse computational environments. The system is designed as a composable pipeline, with the dendritic filtering layer and symbolic quantum search module operating as independent but synergistic components. This modularity facilitates customization and deployment across various platforms, from resource-constrained edge devices to high-performance computing systems. Below, the integration potential is explored in detail for each mentioned environment.

### Edge AI Chips

Integration: Edge AI chips, such as those in wearables, IoT devices, or drones, have limited memory, power, and computational capacity. The invention's low resource footprint, driven by the >90% reduction in processed data, makes it ideal for these platforms. The dendritic filtering layer can be implemented as a lightweight preprocessing step, while the symbolic quantum search can be optimized for fixed-point arithmetic to minimize energy use.
Use Cases: Real-time health monitoring on smartwatches, obstacle detection in autonomous drones, or anomaly detection in industrial IoT sensors.
Advantages: Enables complex AI capabilities on edge devices without requiring cloud connectivity, reducing latency and bandwidth costs. The algorithm's efficiency extends battery life, critical for consumer and industrial applications.
Impact: Accelerates adoption of edge AI in consumer electronics, industrial automation, and military systems, driving innovation in decentralized computing.

### High-Performance Computing Clusters

Integration: High-performance computing (HPC) clusters, used in genomics, finance, or aerospace, handle massive datasets and require scalable algorithms. The invention can be parallelized across cluster nodes, with the dendritic filtering layer distributing data preprocessing and the symbolic quantum search handling candidate ranking. The system's modularity allows integration with existing HPC frameworks, such as MPI or Apache Spark.
Use Cases: Genomic sequencing for personalized medicine, real-time market analysis for trading, or satellite imagery processing for intelligence.
Advantages: The algorithm's ability to denoise and reduce dataset size improves cluster efficiency, reducing computation time and energy costs. Its high precision and recall enhance the quality of HPC outputs, critical for scientific and commercial applications.
Impact: Enables faster and more cost-effective processing of large-scale datasets, supporting breakthroughs in research and industry.

### Quantum-Inspired Reasoning Stacks

Integration: Quantum-inspired reasoning stacks leverage classical hardware to emulate quantum computing principles, such as superposition or entanglement. The invention's symbolic quantum search module, inspired by Grover's algorithm, aligns naturally with these stacks, while the dendritic filtering layer can preprocess inputs to optimize quantum-inspired computations. The system can be integrated into frameworks like D-Wave's Leap or IBM's Qiskit, enhancing their pattern recognition capabilities.
Use Cases: Solving combinatorial optimization problems in logistics, simulating molecular interactions in drug discovery, or enhancing cybersecurity threat detection.
Advantages: The algorithm's quantum-like scoring mechanism complements quantum-inspired architectures, improving their performance on classical hardware. Its modularity allows easy adaptation to evolving quantum-inspired frameworks.
Impact: Bridges the gap between classical and quantum computing, enabling near-term applications of quantum-inspired AI while paving the way for future quantum hardware integration.

### Broader Implications and Future Potential

The invention's versatility across industries and platforms positions it as a foundational technology for next-generation AI systems. Its ability to handle noisy data with high efficiency and accuracy addresses a critical challenge in modern data-driven applications, where datasets are growing in size and complexity. By combining biologically inspired filtering with quantum-inspired search, the algorithm offers a unique blend of robustness, scalability, and adaptability.

Future developments could include:
Hardware Optimization: Custom ASICs or FPGAs designed to accelerate the dendritic filtering and symbolic quantum search, further reducing latency and energy use.
Hybrid Quantum-Classical Systems: Integration with emerging quantum hardware to enhance the symbolic quantum search module, leveraging true quantum speedup.
Cross-Industry Platforms: Development of standardized APIs or software libraries to deploy the algorithm across healthcare, finance, and IoT, fostering interoperability and collaboration.

In summary, the invention offers a biologically inspired, quantum-compatible system for efficient, precise, and robust information retrieval across domains characterized by high noise and uncertainty.

1. (canceled)

2. A computer-implemented method for information retrieval in a dataset comprising a plurality of data samples, each data sample comprising (i) a plurality of continuous-valued sensory features and (ii) a binary vector representation, the method executed by a processor and comprising:
(a) computing, for each of a plurality of dimensions of the continuous-valued sensory features, a per-dimension gating threshold from a distribution of values of that dimension across a training subset of the dataset;
(b) applying a conjunctive filter to each data sample in the dataset, comprising determining, for each data sample, whether every continuous-valued sensory feature of the data sample meets or exceeds its respective per-dimension gating threshold, retaining only data samples for which all continuous-valued sensory features satisfy their respective thresholds, and discarding data samples for which any continuous-valued sensory feature fails to satisfy its respective threshold, thereby producing a filtered dataset, wherein the conjunctive filter is operable to discard every target-labeled data sample of the dataset;
(c) determining whether the filtered dataset contains at least one target-labeled data sample, and responsive to determining that the filtered dataset contains no target-labeled data samples, reinserting at least one target-labeled data sample into the filtered dataset, whereby an intersection of the filtered dataset with a set of target-labeled data samples of the dataset always has a cardinality of at least one prior to step (d), notwithstanding the discarding of step (b);
(d) for each data sample remaining in the filtered dataset after step (c), computing a Hamming distance between the binary vector representation of the data sample and a target binary vector, the computing of step (d) being performed on the binary vector representations of the data samples of the filtered dataset and not on the data samples discarded in step (b);
(e) computing a relevance score for each data sample in the filtered dataset by applying a monotonically decreasing scoring function to the Hamming distance computed in step (d), wherein data samples with lower Hamming distances receive higher relevance scores; and
(f) ranking or classifying the data samples in the filtered dataset based on the relevance scores computed in step (e).

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. The method of claim 2, wherein the set of target-labeled data samples of the dataset constitutes no more than one percent of the data samples of the dataset, and wherein the reinserting of step (c) retains at least one target-labeled data sample in the filtered dataset supplied to step (d) notwithstanding the discarding of step (b).

22. An information retrieval system comprising:
a processor; and
a non-transitory computer-readable medium storing instructions that, when executed by the processor, cause the processor to perform operations on a dataset comprising a plurality of data samples, each data sample comprising (i) a plurality of continuous-valued sensory features and (ii) a binary vector representation, the operations comprising:
(a) computing, for each of a plurality of dimensions of the continuous-valued sensory features, a per-dimension gating threshold from a distribution of values of that dimension across a training subset of the dataset;
(b) applying a conjunctive filter to each data sample in the dataset, comprising determining, for each data sample, whether every continuous-valued sensory feature of the data sample meets or exceeds its respective per-dimension gating threshold, retaining only data samples for which all continuous-valued sensory features satisfy their respective thresholds, and discarding data samples for which any continuous-valued sensory feature fails to satisfy its respective threshold, thereby producing a filtered dataset, wherein the conjunctive filter is operable to discard every target-labeled data sample of the dataset;
(c) determining whether the filtered dataset contains at least one target-labeled data sample, and responsive to determining that the filtered dataset contains no target-labeled data samples, reinserting at least one target-labeled data sample into the filtered dataset, whereby an intersection of the filtered dataset with a set of target-labeled data samples of the dataset always has a cardinality of at least one prior to operation (d), notwithstanding the discarding of operation (b);
(d) for each data sample remaining in the filtered dataset after operation (c), computing a Hamming distance between the binary vector representation of the data sample and a target binary vector, the computing of operation (d) being performed on the binary vector representations of the data samples of the filtered dataset and not on the data samples discarded in operation (b);
(e) computing a relevance score for each data sample in the filtered dataset by applying a monotonically decreasing scoring function to the Hamming distance computed in operation (d), wherein data samples with lower Hamming distances receive higher relevance scores; and
(f) ranking or classifying the data samples in the filtered dataset based on the relevance scores computed in operation (e).

23. The system of claim 22, wherein the monotonically decreasing scoring function is an exponential decay function of the form f(d)=e\hat{ }(−αd), wherein α is a tuning parameter controlling the rate at which relevance scores decrease as the Hamming distance increases.

24. The system of claim 22, wherein reinserting at least one target-labeled data sample comprises at least one of: selecting a known target sample from the training subset of the dataset, and constructing a synthetic data sample whose binary vector representation matches the target binary vector.

25. The system of claim 22, wherein the filtered dataset comprises no more than ten percent of the data samples of the dataset, such that the computing of Hamming distances is performed on no more than ten percent of the data samples of the dataset, and wherein said filtered dataset contains at least one target-labeled data sample notwithstanding said reduction.

26. The system of claim 22, wherein the set of target-labeled data samples of the dataset constitutes no more than one percent of the data samples of the dataset, and wherein the reinserting retains at least one target-labeled data sample in the filtered dataset notwithstanding the discarding.

27. The system of claim 22, wherein the data samples comprise records of transactions or network events, each of the continuous-valued sensory features corresponds to a respective threat criterion of a plurality of threat criteria, the binary vector representation encodes a transaction pattern or a packet sequence, the target binary vector encodes a known fraud or intrusion signature, the conjunctive filter retains only records satisfying every threat criterion of the plurality, and wherein a target-labeled record corresponding to a fraudulent transaction or an intrusion event and discarded by the conjunctive filter is retained in the filtered dataset by the reinserting.

28. A non-transitory computer-readable medium storing instructions that, when executed by a processor, cause the processor to perform a method for information retrieval in a dataset comprising a plurality of data samples, each data sample comprising (i) a plurality of continuous-valued sensory features and (ii) a binary vector representation, the method comprising:
(a) computing, for each of a plurality of dimensions of the continuous-valued sensory features, a per-dimension gating threshold from a distribution of values of that dimension across a training subset of the dataset;
(b) applying a conjunctive filter to each data sample in the dataset, comprising determining, for each data sample, whether every continuous-valued sensory feature of the data sample meets or exceeds its respective per-dimension gating threshold, retaining only data samples for which all continuous-valued sensory features satisfy their respective thresholds, and discarding data samples for which any continuous-valued sensory feature fails to satisfy its respective threshold, thereby producing a filtered dataset, wherein the conjunctive filter is operable to discard every target-labeled data sample of the dataset;
(c) determining whether the filtered dataset contains at least one target-labeled data sample, and responsive to determining that the filtered dataset contains no target-labeled data samples, reinserting at least one target-labeled data sample into the filtered dataset, whereby an intersection of the filtered dataset with a set of target-labeled data samples of the dataset always has a cardinality of at least one prior to step (d), notwithstanding the discarding of step (b);
(d) for each data sample remaining in the filtered dataset after step (c), computing a Hamming distance between the binary vector representation of the data sample and a target binary vector, the computing of step (d) being performed on the binary vector representations of the data samples of the filtered dataset and not on the data samples discarded in step (b);
(e) computing a relevance score for each data sample in the filtered dataset by applying a monotonically decreasing scoring function to the Hamming distance computed in step (d), wherein data samples with lower Hamming distances receive higher relevance scores; and
(f) ranking or classifying the data samples in the filtered dataset based on the relevance scores computed in step (e).

29. The non-transitory computer-readable medium of claim 28, wherein the monotonically decreasing scoring function in step (e) is an exponential decay function of the form f(d)=e\hat{ }(−αd), wherein α is a tuning parameter controlling the rate at which relevance scores decrease as the Hamming distance increases.

30. The non-transitory computer-readable medium of claim 28, wherein the filtered dataset provided to step (d) comprises no more than ten percent of the data samples of the dataset, such that the computing of Hamming distances in step (d) is performed on no more than ten percent of the data samples of the dataset, and wherein said filtered dataset contains at least one target-labeled data sample notwithstanding said reduction.

31. The non-transitory computer-readable medium of claim 28, wherein the set of target-labeled data samples of the dataset constitutes no more than one percent of the data samples of the dataset, and wherein the reinserting of step (c) retains at least one target-labeled data sample in the filtered dataset supplied to step (d) notwithstanding the discarding of step (b).

32. The non-transitory computer-readable medium of claim 28, wherein the continuous-valued sensory features comprise biomarker measurements selected from at least one of protein levels, gene expression profiles, and blood-based analyte concentrations measured in clinical data, the target binary vector encodes a biomarker pattern associated with a disease state, and wherein a target-labeled data sample whose biomarker pattern is associated with said disease state and which is discarded in step (b) by reason of noise in at least one of said continuous-valued sensory features is retained in the filtered dataset by the reinserting of step (c), whereby a diagnostic sensitivity of the ranking or classifying of step (f) is preserved notwithstanding the discarding of step (b).

33. The method of claim 2, wherein the monotonically decreasing scoring function in step (e) is an exponential decay function of the form f(d)=e\hat{ }(−αd), wherein α is a tuning parameter controlling the rate at which relevance scores decrease as the Hamming distance increases.

34. The method of claim 2, wherein reinserting at least one target-labeled data sample in step (c) comprises at least one of: selecting a known target sample from the training subset of the dataset, and constructing a synthetic data sample whose binary vector representation matches the target binary vector.

35. The method of claim 2, wherein the filtered dataset provided to step (d) comprises no more than ten percent of the data samples of the dataset, such that the computing of Hamming distances in step (d) is performed on no more than ten percent of the data samples of the dataset, and wherein said filtered dataset contains at least one target-labeled data sample notwithstanding said reduction.

36. The method of claim 21, wherein the continuous-valued sensory features comprise biomarker measurements selected from at least one of protein levels, gene expression profiles, and blood-based analyte concentrations measured in clinical data, the target binary vector encodes a biomarker pattern associated with a disease state, and wherein a target-labeled data sample whose biomarker pattern is associated with said disease state and which is discarded in step (b) by reason of noise in at least one of said continuous-valued sensory features is retained in the filtered dataset by the reinserting of step (c), whereby a diagnostic sensitivity of the ranking or classifying of step (f) is preserved notwithstanding the discarding of step (b).

37. The method of claim 21, wherein the data samples comprise sequencing reads, the continuous-valued sensory features comprise read quality metrics of the sequencing reads, the binary vector representation encodes a nucleotide sequence of the sequencing read, the target binary vector encodes a reference sequence of a disease-associated gene marker, the Hamming distance computed in step (d) corresponds to a number of positions at which the nucleotide sequence of the sequencing read differs from said reference sequence, and wherein a sequencing read encoding said gene marker and discarded in step (b) by reason of a read quality metric of said sequencing read failing to satisfy its respective per-dimension gating threshold is retained in the filtered dataset by the reinserting of step (c).

38. The method of claim 21, wherein the data samples comprise records of transactions or network events, each of the continuous-valued sensory features corresponds to a respective threat criterion of a plurality of threat criteria, the binary vector representation encodes a transaction pattern or a packet sequence, the target binary vector encodes a known fraud or intrusion signature, the conjunctive filter of step (b) retains only records satisfying every threat criterion of the plurality, and wherein a target-labeled record corresponding to a fraudulent transaction or an intrusion event and discarded in step (b) is retained in the filtered dataset by the reinserting of step (c).
